(19) United States
(12) Patent Application Publication
(10) Pub. No.: US 2025/0067991 A1
(43) Pub. Date: Feb. 27, 2025

(54) VEHICLE DISPLAY DEVICE

(71) Applicant: Jun SHIHAKU, Shizuoka (JP)

(72) Inventor: Jun SHIHAKU, Shizuoka (JP)

(21) Appl. No.: 18/942,933

(22) Filed: Nov. 11, 2024

Related U.S. Application Data
(63) Continuation of application No. PCT/JP2023/018549, filed on May 18, 2023.

(30) Foreign Application Priority Data
Jun. 14, 2022 (JP) 2022-095472

(51) Int. Cl. G02B 27/01

(52) U.S. Cl. CPC G02B 27/0179; G02B 27/0149; G02B 2027/0159; G02B 2027/0187

(57) ABSTRACT

A vehicle display device includes: a display device; a mirror configured to reflect display light of an image toward a reflective surface disposed in front of a driver; a motor configured to change a projection position of the display light in a vehicle upper and lower direction by rotating the mirror; reference data defining a correspondence relation between a plurality of reference points and warping shapes, the warping shapes corresponding to the respective reference points; and a controller configured to set an eye box for control, and generate a warping shape for display on the display device based on coordinates of a representative point of the eye box for control and the reference data. The controller updates the eye box for control and the warping shape for display in a case in which a position of an eye becomes a position outside the eye box for control.

### CROSS-REFERENCE TO RELATED APPLICATION

This application is a continuation application of International Application No. PCT/JP2023/018549 filed on May 18, 2023 which claims the benefit of priority from Japanese Patent Application No. 2022-095472 filed on Jun. 14, 2022 and designating the U.S., the entire contents of which are incorporated herein by reference.

### BACKGROUND OF THE INVENTION

### 1. Field of the Invention

The present invention relates to a vehicle display device.

### 2. Description of the Related Art

In the related art, there is known a technique of performing warping processing in image display for a vehicle. Japanese Patent Application Laid-open No. 2015-087619 discloses a vehicle information projection system. The vehicle information projection system according to Japanese Patent Application Laid-open No. 2015-087619 previously stores, in a ROM (storage unit), an image conversion table in which a reference viewpoint position is associated with a reference warping parameter for converting image data to previously display a distorted display image on a display. This vehicle information projection system interpolates an image conversion table suitable for a detected viewpoint position using the reference viewpoint position and the reference warping parameter.

If a warping shape is frequently changed, a driver may feel annoyed. For example, in a case in which a position of an eye of the driver slightly moves and immediately returns to an original position, it is assumed that the warping shape is changed in accordance with the first movement, and the warping shape is restored in accordance with the movement of immediately returning to the original position. If the warping shape is changed as described above, the driver may feel a sense of incongruity for switching of an image.

### SUMMARY OF THE INVENTION

An object of the present invention is to provide a vehicle display device that can adjust a warping shape in accordance with a position of an eye while suppressing a sense of incongruity given to a driver.

In order to achieve the above mentioned object, a vehicle display device according to one aspect of the present invention includes: a display device configured to display an image; a mirror configured to reflect display light of the image toward a reflective surface disposed in front of a driver; a motor configured to change a projection position of the display light in a vehicle upper and lower direction by rotating the mirror; a reference data defining a correspondence relation between a plurality of reference points and warping shapes, the reference points being located along the vehicle upper and lower direction and a vehicle width direction set for an eye range, the warping shapes corresponding to the respective reference points; an acquisition unit configured to acquire a position of an eye of the driver; and a controller configured to set an eye box for control, and generate a warping shape for display on the display device based on coordinates of a representative point of the eye box for control and the reference data, wherein the controller updates the eye box for control and the warping shape for display in a case in which the position of the eye becomes a position outside the eye box for control.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic configuration diagram of a vehicle display device according to an embodiment;

FIG. 2 is a diagram illustrating reference points according to the embodiment;

FIG. 3 is a diagram illustrating an eye range and an eye box for control according to the embodiment;

FIG. 4 is a diagram illustrating the eye box for control according to the embodiment;

FIG. 5 is a diagram illustrating data for reference according to the embodiment;

FIG. 6 is a flowchart illustrating an operation according to the embodiment;

FIG. 7 is a diagram illustrating an example of a movement pattern of a position of an eye;

FIG. 8 is a diagram illustrating another example of a movement pattern of the position of the eye;

FIG. 9 is a diagram illustrating movement of the position of the eye;

FIG. 10 is a diagram for explaining generation of a new warping shape;

FIG. 11 is a diagram for explaining generation of a new warping shape;

FIG. 12 is a diagram for explaining generation of a new warping shape;

FIG. 13 is a diagram for explaining generation of a new warping shape;

FIG. 14 is a diagram illustrating intermediate points according to the embodiment;

FIG. 15 is a diagram for explaining update of an eye box for control according to a first modification of the embodiment; and

FIG. 16 is a diagram illustrating intermediate points according to a second modification of the embodiment.

### DETAILED DESCRIPTION OF THE PREFERRED EMBODIMENTS

The following describes a vehicle display device according to an embodiment of the present invention in detail with reference to the drawings. The present invention is not limited to the embodiment. Constituent elements in the following embodiment include a constituent element that is easily conceivable by those skilled in the art and substantially the same constituent element.

### EMBODIMENT

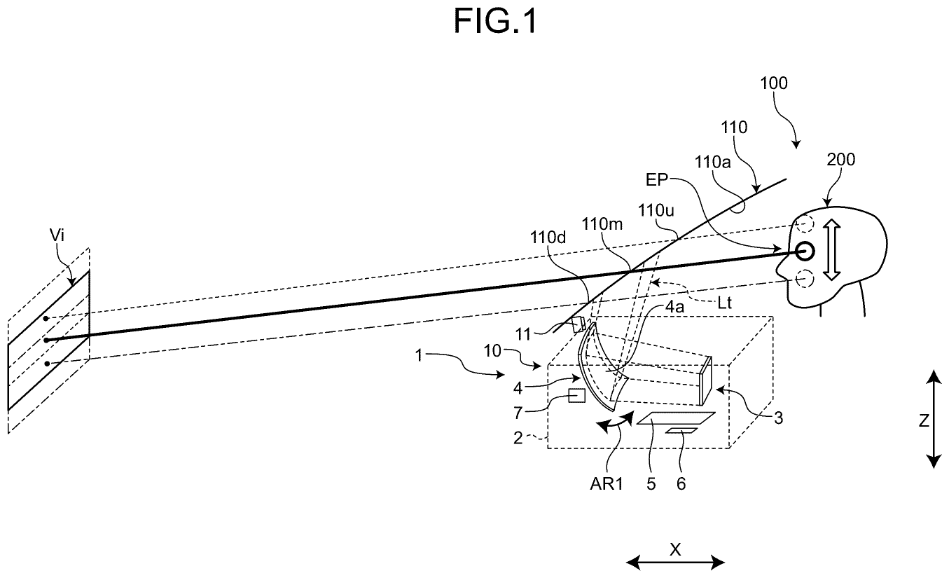

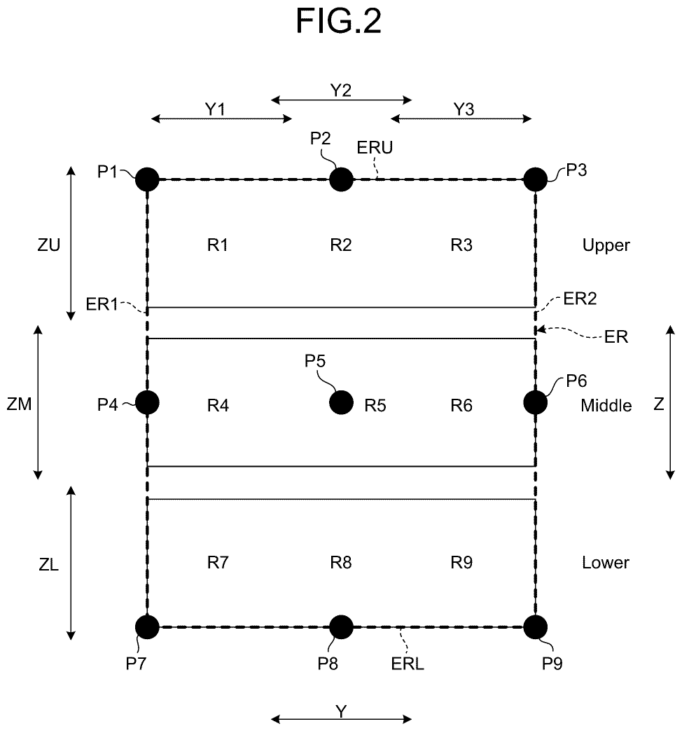

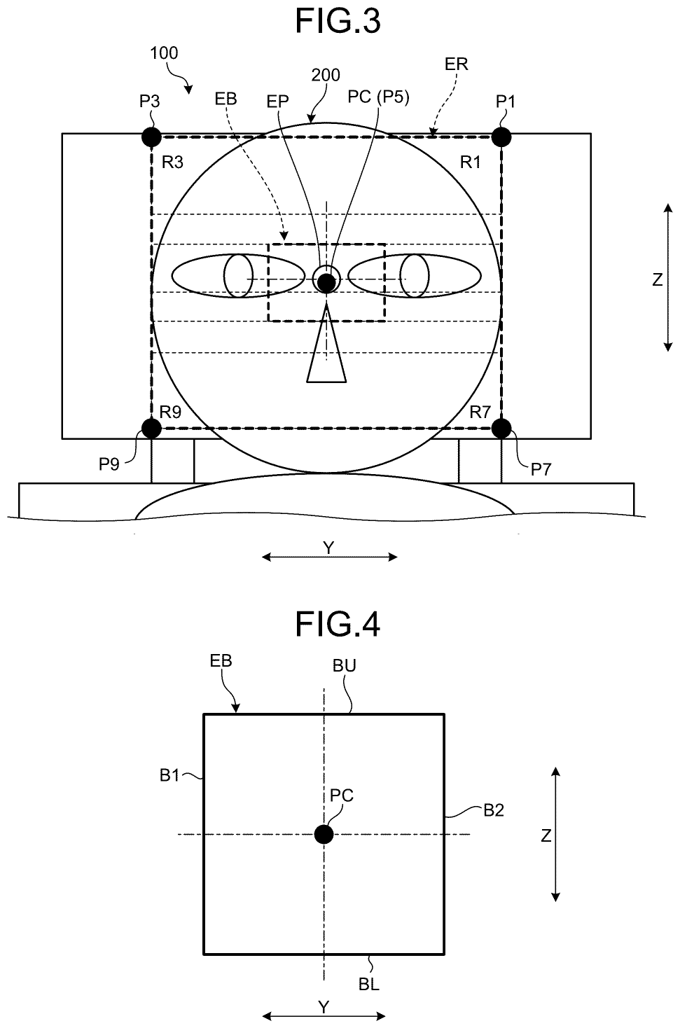

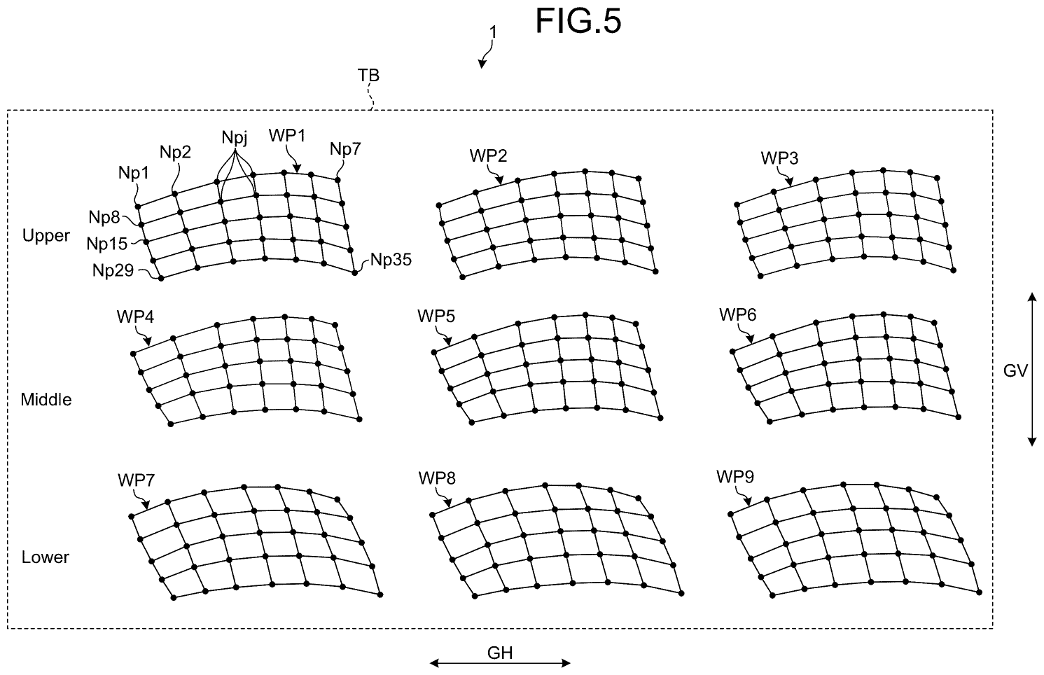

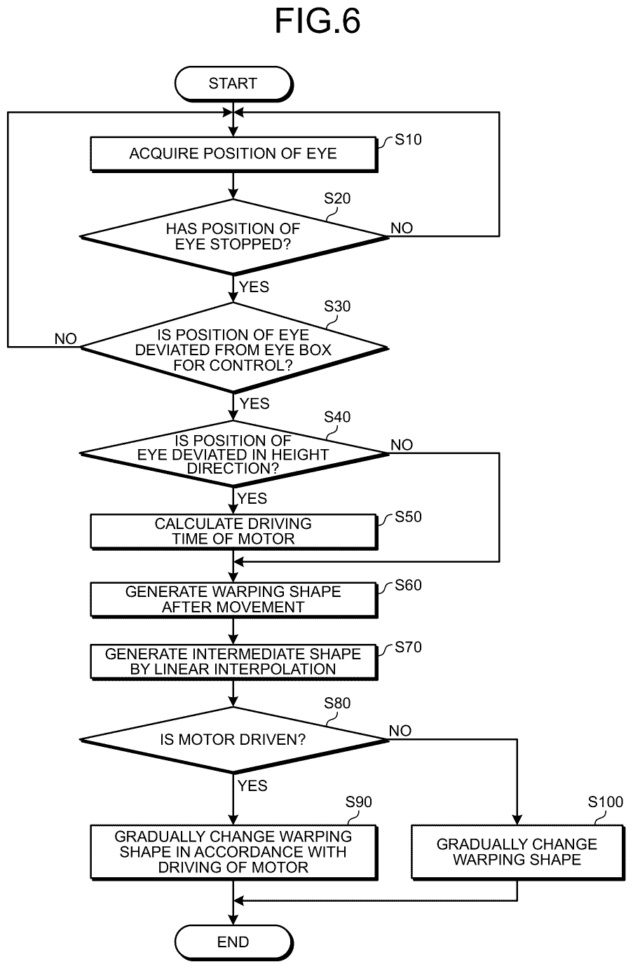

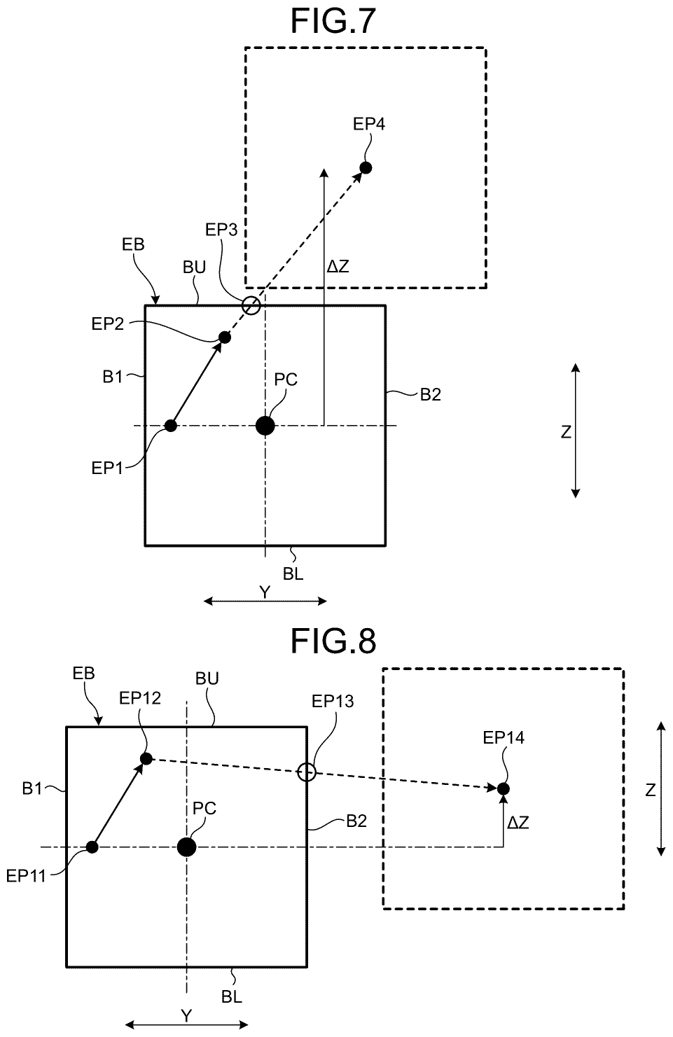

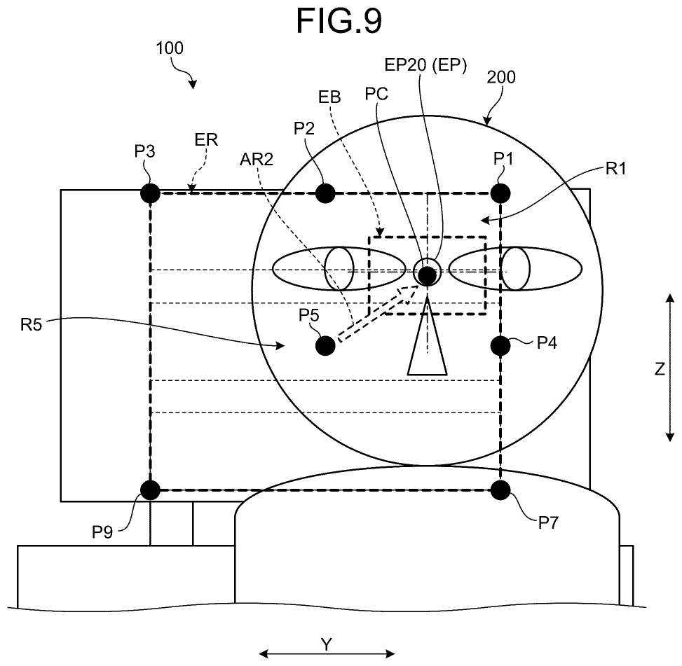

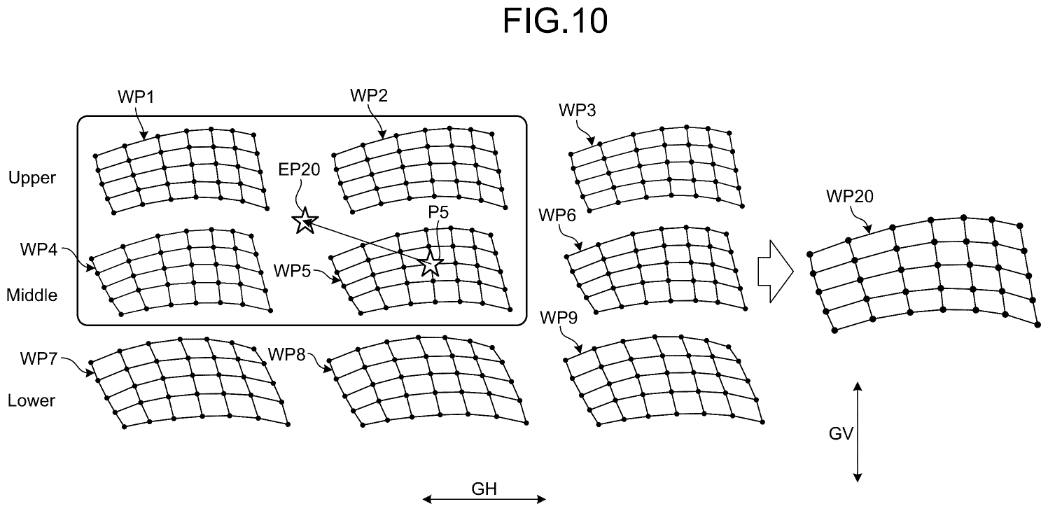

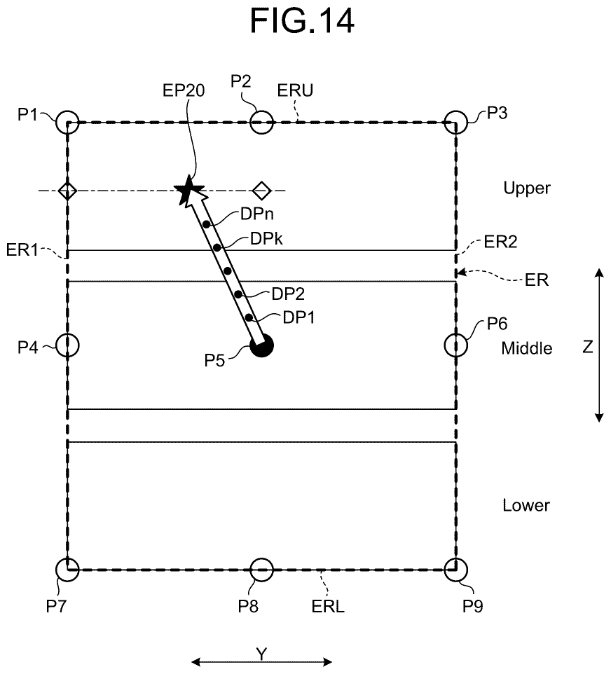

With reference to FIG. 1 to FIG. 14, the following describes the embodiment. The present embodiment relates to a vehicle display device. FIG. 1 is a schematic configuration diagram of the vehicle display device according to the embodiment, FIG. 2 is a diagram illustrating reference points according to the embodiment, FIG. 3 is a diagram illustrating an eye range and an eye box for control according to the embodiment, FIG. 4 is a diagram illustrating the eye box for control according to the embodiment, FIG. 5 is a diagram illustrating data for reference according to the embodiment, FIG. 6 is a flowchart illustrating an operation according to the embodiment, FIG. 7 and FIG. 8 are diagrams illustrating movement patterns of a position of an eye, FIG. 9 is a diagram illustrating movement of the position of the eye, FIG. 10 to FIG. 13 are diagrams for explaining generation of a new warping shape, and FIG. 14 is a diagram illustrating intermediate points according to the embodiment.

As illustrated in FIG. 1, a display device 1 for vehicles according to the present embodiment is a head-up display device mounted on a vehicle 100 such as an automobile. The display device 1 for vehicles projects display light Lt of an image toward a windshield 110. The windshield 110 is positioned on a front side of the vehicle with respect to an eye point EP of the vehicle 100, and opposed to the eye point EP in a vehicle front and rear direction X. The display light Lt is reflected by a reflective surface 110a of the windshield 110 toward the eye point EP. A driver of the vehicle 100 can visually recognize a virtual image Vi by the display light Lt.

The display device 1 for vehicles according to the present embodiment can change a projection position of an image on the windshield 110 in an upper and lower direction. For example, the display device 1 for vehicles raises or lowers the projection position of the image on the windshield 110 based on a position of the eye point EP. The eye point EP is a position of an eye of a driver 200, and detected by using a camera 11 of the display device 1 for vehicles, for example. The exemplified camera 11 is disposed on the front side of the vehicle with respect to a driver's seat, and installed to be able to image the driver 200. The eye point EP is detected by image recognition on an image generated by the camera 11.

The display device 1 for vehicles includes an image display unit 10 mounted on the vehicle 100. The image display unit 10 includes a housing 2, a display device 3, a mirror 4, a controller 5, a nonvolatile memory 6, and a motor 7. The housing 2 is disposed inside an instrument panel, for example. The housing 2 has an opening opposed to the windshield 110. The display device 3, the mirror 4, the controller 5, the nonvolatile memory 6, and the motor 7 are housed inside the housing 2.

The display device 3 is a device that displays an image, for example, a liquid crystal display device. The display device 3 may be a Thin Film Transistor-Liquid Crystal Display (TFT-LCD). The display device 3 may output the display light Lt by light of a backlight unit, for example.

The mirror 4 reflects the display light Lt of the image toward the reflective surface 110a of the windshield 110. The display light Lt reflected by the mirror 4 passes through the opening of the housing 2 to be projected onto the reflective surface 110a of the windshield 110. The mirror 4 includes a concave reflective surface 4a, and can magnify the image. A shape of the reflective surface 4a is, for example, a free curved surface. The shape of the reflective surface 4a may be a shape for correcting distortion or aberration of the image.

The image display unit 10 according to the present embodiment includes the motor 7 that rotates the mirror 4. The mirror 4 is supported in a rotatable manner. A rotation direction of the mirror 4 is a direction for changing an inclination angle of the reflective surface 4a with respect to a vehicle upper and lower direction Z as indicated by an arrow AR1 in FIG. 1. As the inclination angle of the mirror 4 is increased, the projection position of the image on the windshield 110 moves downward. On the other hand, as the inclination angle of the mirror 4 is decreased, the projection position of the image on the windshield 110 moves upward.

The motor 7 rotates the mirror 4 to adjust the inclination angle of the reflective surface 4a to be a desired angle. The motor 7 is, for example, a stepping motor. The motor 7 is driven by a command value output from the controller 5. The command value includes a rotation direction and the number of steps of the motor 7.

The controller 5 controls the display device 3 and the motor 7. The controller 5 is, for example, a computer including an arithmetic unit, a memory, a communication interface, and the like. The controller 5 controls the motor 7 in accordance with a computer program stored in advance, for example. The controller 5 controls the display device 3 based on the computer program stored in advance, and a reference data TB read from the nonvolatile memory 6.

The controller 5 according to the present embodiment generates a warping shape for display on the display device 3 based on the position of the eye point EP. Detection of the eye point EP based on an imaging result of the camera 11 may be performed by the controller 5, or may be performed by another processing unit. The camera 11 may include a processing unit for detecting the eye point EP.

As described below with reference to FIG. 2, in the present embodiment, a plurality of regions are set for an eye range ER of the vehicle 100. The eye range ER statistically represents distribution of positions of the eye of the driver, and is a region along a vehicle width direction Y and the vehicle upper and lower direction Z. A shape of the exemplified eye range ER is a rectangle. As illustrated in FIG. 2, three ranges ZU, ZM, and ZL in the vehicle upper and lower direction Z are set for the eye range ER. The range ZU on an upper side is a range on the uppermost side of the eye range ER. The range ZM in the middle is a middle range of the eye range ER. The range ZL on a lower side is a range on the lower side of the eye range ER. The three ranges ZU, ZM, and ZL may overlap with each other at a boundary part.

Additionally, three ranges Y1, Y2, and Y3 in the vehicle width direction Y are set for the eye range ER. The first range Y1 is a range on one end side in the vehicle width direction Y of the eye range ER. The first range Y1 is, for example, a range on a left end side when viewed from the driver. The second range Y2 is a middle range in the vehicle width direction Y of the eye range ER. The third range Y3 is a range on the other end side in the vehicle width direction Y of the eye range ER. The third range Y3 is, for example, a range on a right end side when viewed from the driver. The three ranges Y1, Y2, and Y3 may overlap with each other at a boundary part.

Nine regions are set for the eye range ER. A first region R1, a second region R2, and a third region R3 are set for the range ZU on the upper side. The regions R1, R2, and R3 correspond to the ranges Y1, Y2, and Y3, respectively. A fourth region R4, a fifth region R5, and a sixth region R6 are set for the middle range ZM. The regions R4, R5, and R6 correspond to the ranges Y1, Y2, and Y3, respectively. A seventh region R7, an eighth region R8, and a ninth region R9 are set for the range ZL on the lower side. The regions R7, R8, and R9 correspond to the ranges Y1, Y2, and Y3, respectively.

Each region Ri (i=1, 2, . . . , 9) includes a reference . . . point Pi (i=1, 2, . . . , 9). For example, the fifth region R5 includes a reference point P5. The reference point P5 is, for example, a center point of the eye range ER. Reference points P1 to P4, and P6 to P9 of the regions R1 to R4, and R6 to R9 except the fifth region R5 are set on a boundary line of the eye range ER. The eye range ER includes a boundary line ERU at an upper end, a boundary line ERL at a lower end, a first boundary line ER1 at one end in the vehicle width direction Y, and a second boundary line ER2 at the other end in the vehicle width direction Y.

The reference point P1 of the first region R1 is set at an apex of the eye range ER. More specifically, the reference point P1 is positioned at an intersection point of the boundary line ERU at the upper end and the first boundary line ER1. Similarly, the reference points P3, P7, and P9 of the third region R3, the seventh region R7, and the ninth region R9 are set at apexes of the eye range ER, respectively. More specifically, the reference point P3 of the third region R3 is positioned at an intersection point of the boundary line ERU at the upper end and the second boundary line ER2. The reference point P7 of the seventh region R7 is positioned at an intersection point of the boundary line ERL at the lower end and the first boundary line ER1. The reference point P9 of the ninth region R9 is positioned at an intersection point of the boundary line ERL at the lower end and the second boundary line ER2.

The reference point P2 of the second region R2 is positioned at the center in the vehicle width direction Y on the boundary line ERU at the upper end. The reference point P4 of the fourth region R4 is positioned at the center in the vehicle upper and lower direction Z on the first boundary line ER1. The reference point P6 of the sixth region R6 is positioned at the center in the vehicle upper and lower direction Z on the second boundary line ER2. The reference point P8 of the eighth region R8 is positioned at the center in the vehicle width direction Y on the boundary line ERL at the lower end. Each reference point Pi is associated with a piece of warping data WPi (i=1, 2, . . . , 9) illustrated in FIG. 5.

The controller 5 according to the present embodiment sets an eye box EB for control illustrated in FIG. 3. The eye box EB for control is a range along the vehicle width direction Y and the vehicle upper and lower direction Z. A shape of the exemplified eye box EB for control is a rectangle. The eye box EB for control is set based on the detected eye point EP. The eye point EP is, for example, an intermediate position between a left eye and a right eye of the driver 200. In FIG. 3, the eye point EP is positioned at the reference point P5 at the center. In this case, the eye box EB for control is set to overlap with the fifth region R5 illustrated in FIG. 2. FIG. 3 is a diagram in which the driver 200 is viewed from the front side, so that the left side and the right side are flipped as compared with FIG. 2.

As illustrated in FIG. 4, the eye box EB for control includes a boundary line BU at an upper end, a boundary line BL at a lower end, a first boundary line B1, and a second boundary line B2. The boundary line BU at the upper end is a boundary line at the upper end in the vehicle upper and lower direction Z of the eye box EB for control. The boundary line BL at the lower end is a boundary line at the lower end of the eye box EB for control. The first boundary line B1 is a boundary line at one end in the vehicle width direction Y of the eye box EB for control. The second boundary line B2 is a boundary line at the other end in the vehicle width direction Y of the eye box EB for control.

The eye box EB for control includes a representative point PC. A position of the exemplified representative point PC is a center point or a centroid point of the eye box EB for control. In a case of newly setting the eye box EB for control or a case of updating the eye box EB for control, the controller 5 sets the position of the eye box EB for control to cause the representative point PC to agree with the detected eye point EP. As described later, the controller 5 according to the present embodiment does not update the warping shape for display while the eye is positioned inside the eye box EB for control, and updates the warping shape for display in a case in which the position of the eye is deviated from the eye box EB for control. Due to this, frequent update of the warping shape is suppressed.

As illustrated in FIG. 5, the display device 1 for vehicles according to the present embodiment includes the reference data TB including a plurality of the warping shapes. The reference data TB is data defining a correspondence relation between the reference points P1 to P9 and pieces of the warping data WP1 to WP9. The pieces of warping data WP1 to WP9 are pieces of data for defining image display regions on the display device 3. The pieces of warping data WP1 to WP9 are set to be able to correct distortion of an image caused by reflection by the reflective surface 110a of the windshield 110.

The warping data WP1 is data of a warping shape corresponding to the reference point P1 of the first region R1. Similarly, the pieces of warping data WP2 to WP9 are pieces of data of warping shapes corresponding to the reference points P2 to P9 of the regions R2 to R9. Each piece of the warping data WPi (i=1, 2, . . . , 9) includes a plurality of inflection points Npj (j=1, 2, . . . ). The inflection points Npj are arranged in a gridlike fashion along an image horizontal direction GH and an image vertical direction GV. That is, the inflection point Npj is a grid point of the warping shape. Each inflection point Npj has a coordinate value in the vehicle width direction Y and a coordinate value in the vehicle upper and lower direction Z.

The warping data WP1 is optically designed to correct distortion of the image when the eye point EP is positioned at the reference point P1. Similarly, optical design of the pieces of warping data WP2 to WP9 is optimized to be able to correct distortion of the image when the eye point EP is positioned at the reference points P2 to P9.

The controller 5 according to the present embodiment generates the warping shape for the eye box EB for control based on the reference data TB. The controller 5 causes the display device 3 to display an image based on the generated warping shape. More specifically, the controller 5 performs coordinate transformation on an original image based on the generated warping shape, and generates the image for display. That is, the controller 5 generates the image for display by distorting the image to be visually recognized by the driver 200 based on the generated warping shape. The controller 5 causes the display device 3 to display the generated image for display.

As described below, the controller 5 according to the present embodiment does not change the eye box EB for control while the eye of the driver 200 is positioned inside the eye box EB for control. Thus, the controller 5 uses the same warping shape as long as the eye is positioned inside the eye box EB for control. Due to this, annoyance caused by frequent change of the warping shape can be suppressed.

On the other hand, the controller 5 updates the eye box EB for control in a case in which the position of the eye of the driver 200 becomes a position outside the eye box EB for control. In a case in which the eye box EB for control is updated, the controller 5 updates the warping shape for display based on the updated eye box EB for control. Due to this, when the position of the eye moves, the image can be displayed with an appropriate warping shape corresponding to the position of the eye after the movement.

The following describes an operation of the display device 1 for vehicles according to the present embodiment with reference to the flowchart of FIG. 6. At Step S10, the position of the eye is acquired. The controller 5 acquires the position of the eye of the driver 200 based on the image generated by the camera 11. After Step S10 is performed, the process proceeds to Step S20.

At Step S20, the controller 5 determines whether the position of the eye has stopped. A condition for determining that the position of the eye has stopped is optional. For example, the controller 5 may determine that the eye point EP has stopped in a case in which a moving speed of the position of the eye becomes smaller than a lower limit value. For example, the controller 5 may determine that the position of the eye has stopped in a case in which the position of the eye does not come out of a predetermined range within a certain period of time. If affirmative determination is made such that the position of the eye has stopped at Step S20, the process proceeds to Step S30. If negative determination is made, the process proceeds to Step S10.

At Step S30, the controller 5 determines whether the position of the eye is deviated from the eye box EB for control. FIG. 7 illustrates an example of a movement pattern of the position of the eye. The detected position of the eye moves from a point EP1 to a point EP2, passes through a point EP3 thereafter, and stops at a point EP4. The position of the eye continuously moves from the point EP1 to the point EP4, and stops at the point EP4. Both of the points EPI and EP2 are points inside the eye box EB for control. The point EP3 is a point on the boundary line BU at the upper end.

When the position of the eye stops at the point EP4, the controller 5 determines whether the point EP4 is a point outside the eye box EB for control. In a case in which the point EP4 is a point outside the eye box EB for control, the controller 5 determines that the position of the eye is deviated from the eye box EB for control. If affirmative determination is made at Step S30, the process proceeds to Step S40. If negative determination is made, the process proceeds to Step S10. If affirmative determination is made at Step S30, the controller 5 updates the eye box EB for control. With reference to FIG. 7, the controller 5 sets a new eye box EB for control for the point EP4 at which the position of the eye has stopped. The new eye box EB for control is indicated by a dashed line in FIG. 7. The representative point PC of the new eye box EB for control is the point EP4.

At Step S40, the controller 5 determines whether the position of the eye is deviated in a height direction. In the example of FIG. 7, the position of the eye intersects the boundary line BU at the upper end when being deviated from the eye box EB for control. The controller 5 may determine that the position of the eye is deviated in the height direction in a case in which the position of the eye intersects the boundary line BU at the upper end, and a case in which the position of the eye intersects the boundary line BL at the lower end.

The controller 5 may determine that the position of the eye is deviated in the height direction in a case in which the motor 7 is required to be driven due to update of the eye box EB for control. In the example of FIG. 7, the point EP4 is positioned on an upper side in the vehicle upper and lower direction Z than the boundary line BU at the upper end. In other words, the position of the eye is deviated from the eye box EB for control in the height direction. The controller 5 can perform determination at Step S40 based on relative positions of the stopped position of the eye and the eye box EB for control.

For example, the controller 5 determines whether the motor 7 is required to be driven based on a movement amount ΔZ of the position of the eye along the vehicle upper and lower direction Z. The movement amount AZ of the position of the eye is, for example, a difference between a Z-coordinate of the representative point PC and a Z-coordinate of the stopped position of the eye.

Regarding the movement amount AZ of the position of the eye, the controller 5 preferably has a threshold for determining whether to drive the motor 7. In a case in which an absolute value of the movement amount AZ of the position of the eye is larger than the threshold, the controller 5 determines to drive the motor 7 to rotate the mirror 4. A height of the eye box EB for control may be set based on this threshold. The threshold may be equal to a height from the representative point PC to the boundary line BU at the upper end, for example. The threshold may be equal to a height from the representative point PC to the boundary line BL at the lower end, for example.

FIG. 8 illustrates another example of the movement pattern of the position of the eye. The detected position of the eye moves from a point EP11 to a point EP12, passes through a point EP13 thereafter, and stops at a point EP14. Both of the points EP11 and EP12 are points inside the eye box EB for control. The point EP13 is a point on the second boundary line B2. The point EP14 is a point outside the eye box EB for control.

In the example of FIG. 8, the position of the eye intersects the second boundary line B2 when being deviated from the eye box EB for control. The controller 5 may determine that the position of the eye is deviated in the vehicle width direction Y in a case in which the position of the eye intersects the second boundary line B2, and a case in which the position of the eye intersects the first boundary line B1. In this case, the controller 5 may determine that the position of the eye is not deviated in the height direction.

The controller 5 may determine that the position of the eye is deviated in the vehicle width direction Y in a case in which the motor 7 is not required to be driven due to update of the eye box EB for control. For example, in a case in which the movement amount AZ of the position of the eye is equal to or smaller than the threshold, the controller 5 may make negative determination at Step S40.

As a result of the determination at Step S40, the process proceeds to Step S50 if affirmative determination is made such that the position of the eye is deviated in the height direction, and the process proceeds to Step S60 if negative determination is made.

At Step S50, the controller 5 calculates a driving time of the motor 7. For example, the controller 5 calculates the driving time of the motor 7 based on a relative position of the eye box EB for control after the update with respect to the eye box EB for control before the update. In this case, the controller 5 can calculate a required rotation amount of the motor 7 based on the movement amount AZ of the position of the eye. The motor 7 according to the present embodiment is a stepping motor, so that the controller 5 calculates the number of steps of motor driving. The controller 5 calculates the driving time as a time required for rotation of the motor 7 based on the number of steps of driving. After Step S50 is performed, the process proceeds to Step S60.

At Step S60, the controller 5 generates a warping shape after the movement. The warping shape after the movement is a warping shape corresponding to the new eye box EB for control. With reference to FIG. 9 to FIG. 12, the following describes generation of the warping shape.

In FIG. 9, movement of the position of the eye is indicated by an arrow AR2. In FIG. 9, the position of the eye before the movement is the reference point P5 at the center, and the position of the eye after the movement is a point EP20. The point EP20 is a point in the first region R1. The point EP20 is surrounded by the four reference points P1, P2, P4, and P5. In other words, the point EP20 is a point inside a rectangular region formed by the reference points P1, P2, P4, and P5.

As illustrated in FIG. 10, the controller 5 generates a new warping shape WP20 from the four pieces of warping data WP1, WP2, WP4, and WP5. The new warping shape WP20 is a warping shape corresponding to the point EP20.

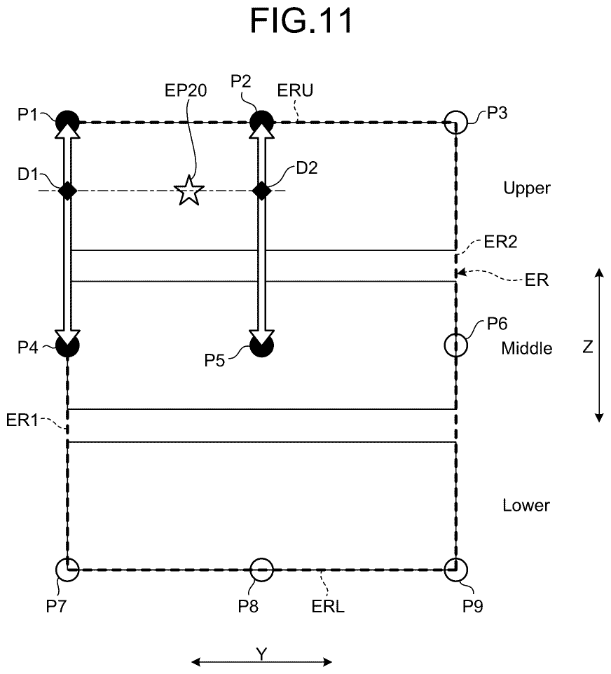

As described below with reference to FIG. 11, the controller 5 according to the present embodiment calculates a first point DI and a second point D2 based on two reference points Pi aligned in the vehicle upper and lower direction Z. The first point DI and the second point D2 are points corresponding to the point EP20 in the vehicle upper and lower direction Z. The first point DI is a point between the two reference points P1 and P4. That is, the first point DI is a point internally dividing between the reference point P1 and the reference point P4. The second point D2 is a point between the two reference points P2 and P5. That is, the second point D2 is a point internally dividing between the reference point P2 and the reference point P5.

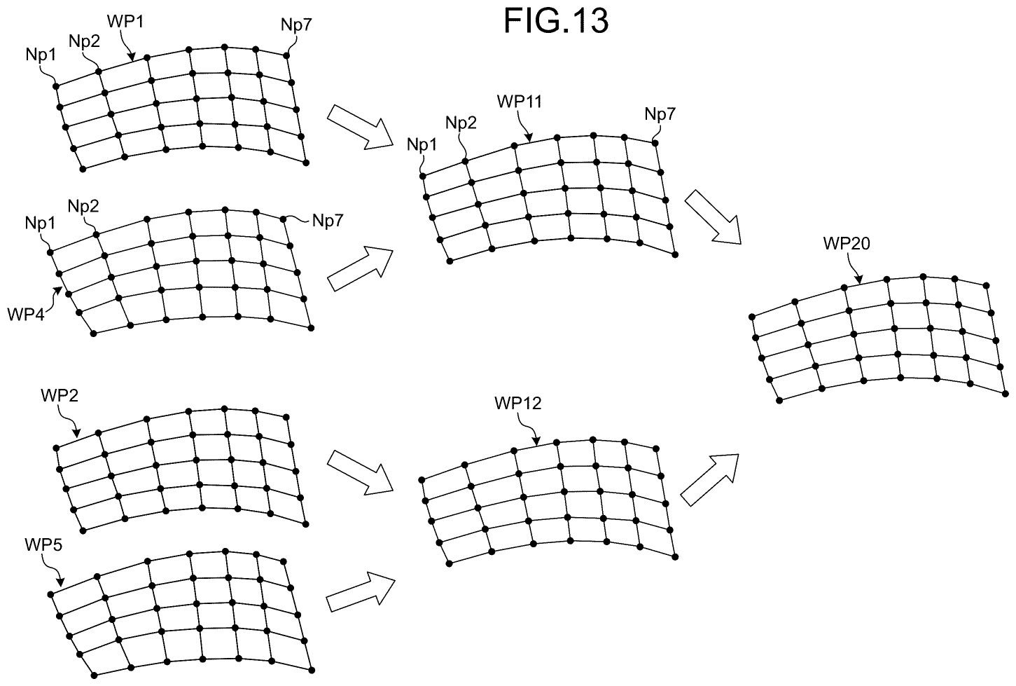

As illustrated in FIG. 13, the controller 5 generates a warping shape WP11 corresponding to the first point DI by linear interpolation based on the two pieces of warping data WP1 and WP4. This linear interpolation is based on an internal division ratio calculated from Z-coordinates of the reference points P1 and P4, and the first point D1. For example, the controller 5 calculates coordinate values of the inflection point Npj of the warping shape WP11 based on coordinate values of corresponding inflection points Npj of the two pieces of warping data WP1 and WP4. Thus, as the first point DI is closer to the reference point P1, similarity between the warping shape WP11 and the warping data WP1 becomes higher. On the other hand, as the first point DI is closer to the reference point P4, similarity between the warping shape WP11 and the warping data WP4 becomes higher. Similarly, the controller 5 generates a warping shape WP12 corresponding to the second point D2 by linear interpolation based on the two pieces of warping data WP2 and WP5.

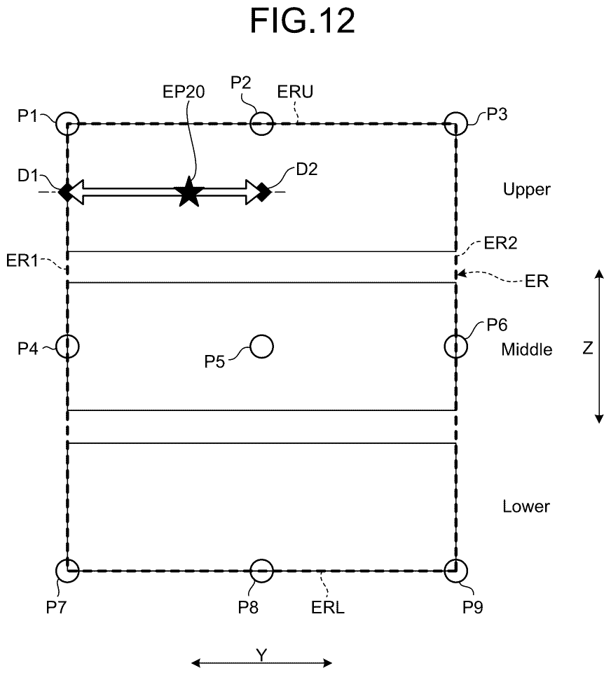

The controller 5 generates the new warping shape WP20 by linear interpolation based on the warping shapes WP11 and WP12. As illustrated in FIG. 12, the point EP20 is a point internally dividing between the first point D1 and the second point D2. An internal division ratio at this time is calculated from Y-coordinates of the first point D1, the second point D2, and the point EP20. For example, the controller 5 performs linear interpolation based on this internal division ratio. When the new warping shape WP20 is generated at Step S60, the process proceeds to Step S70.

At Step S70, an intermediate shape is generated by linear interpolation. The intermediate shape is a warping shape at an intermediate stage between the warping shape before the update and the warping shape after the update. In the example of FIG. 9, the warping shape before the update is the warping data WP5. The warping shape after the update is the new warping shape WP20. In this case, the controller 5 generates an intermediate shape by linear interpolation based on the warping data WP5 and the new warping shape WP20.

As illustrated in FIG. 14, the controller 5 may set intermediate points DPk (k=1, 2, . . . , n) between the reference point P5 and the point EP20. The number n of the intermediate points DPk may be one or multiple. The intermediate point DPk may be a point that equally divides between a start point and a goal point. The controller 5 generates an intermediate shape by linear interpolation for each of the intermediate points DPk. For example, in a case in which the number n of the intermediate points DPk is 5, the controller 5 generates five intermediate shapes. Similarity between the intermediate shape and the new warping shape WP20 becomes higher as being closer to the point EP20 from the reference point P5. When the intermediate shapes are generated, the process proceeds to Step S80.

At Step S80, the controller 5 determines whether the motor is driven. This determination may be the same as the determination at Step S40, for example. For example, in a case in which it is determined that the position of the eye is deviated in the height direction at Step S40, it is determined that the motor is driven at Step S80. As a result of the determination at Step S80, the process proceeds to Step S90 if affirmative determination is made such that the motor is driven, and the process proceeds to Step S100 if negative determination is made.

At Step S90, the controller 5 gradually changes the warping shape in accordance with driving of the motor 7. For example, the controller 5 changes the warping shape in accordance with a motor driving time and a screen updating time. For example, the controller 5 starts to change the warping shape in a stepwise manner in synchronization with the start of driving of the motor 7. The controller 5 ends the change of the warping shape in synchronization with the end of driving of the motor 7, for example.

At the timing when a rotational position of the motor 7 becomes a position corresponding to the intermediate point DP1, for example, the controller 5 updates the warping shape to the intermediate shape corresponding to the intermediate point DP1. Furthermore, at the timing when the rotational position of the motor 7 becomes a position corresponding to the intermediate point DP2, the warping shape is updated to the intermediate shape corresponding to the intermediate point DP2. Finally, at the timing when the rotational position of the motor 7 becomes a position corresponding to EP20, the warping shape is updated to the new warping shape WP20. In this way, when the warping shape is updated in a stepwise manner in accordance with driving of the motor 7, display can be smoothly switched without causing a sense of incongruity.

The controller 5 may set a switching timing for the warping shape based on a frame rate [number of frames/second] of the display device 3. For example, the warping shape may be changed between one frame and the next frame. Driving of the motor 7 and update of the warping shape are completed, the flowchart ends.

At Step S100, the controller 5 gradually changes the warping shape. For example, the controller 5 changes the warping shape in accordance with a predefined time and a screen updating time. The predefined time is a variable, and determined in advance so that the driver 200 hardly feels a sense of incongruity. The controller 5 changes the warping shape as the predefined time has elapsed, for example. The controller 5 may set the switching timing for the warping shape between the frames. When update of the warping shape is completed, the flowchart ends.

As described above, the display device 1 for vehicles according to the present embodiment includes the display device 3 for displaying an image, the mirror 4, the motor 7, the reference data TB, the camera 11, and the controller 5. The mirror 4 reflects the display light Lt of the image toward the reflective surface 110a that is disposed in front of the driver 200. The motor 7 changes the projection position of the display light Lt in the vehicle upper and lower direction Z by rotating the mirror 4. The reference data TB is data defining a correspondence relation between the reference points Pi and the pieces of warping data WPi corresponding to the respective reference points Pi. The reference points Pi are set for the eye range ER, and arranged along the vehicle upper and lower direction Z and the vehicle width direction Y.

The camera 11 is an example of an acquisition unit that acquires the position of the eye of the driver 200. The acquisition unit may include a processing unit that performs image processing or image recognition on an image taken by the camera 11. This processing unit may be an arithmetic circuit included in the controller 5, or a processing program executed by the controller 5. The controller 5 sets the eye box EB for control. The controller 5 generates the warping shape for display on the display device 3 based on the coordinates of the representative point PC of the eye box EB for control and the reference data TB.

The warping shape for display may be generated from a plurality of the warping shapes included in the reference data TB, or may be any of the warping shapes included in the reference data TB. For example, in a case in which the position of the eye agrees with any one of the reference points Pi, the warping shape of the reference point Pi becomes the warping shape for display.

The controller 5 updates the eye box EB for control and the warping shape for display in a case in which the position of the eye becomes a position outside the eye box EB for control. In other words, the controller 5 updates the eye box EB for control and the warping shape for display when the position of the eye becomes a position outside the eye box EB for control as one of conditions. Thus, the controller 5 does not update the eye box EB for control and the warping shape at least while the eye is positioned inside the eye box EB for control. Due to this, frequent update of the warping shape is suppressed, and the driver 200 hardly feels annoyance.

In a case in which the position of the eye comes out of the eye box EB for control, the controller 5 according to the present embodiment does not start to update the eye box EB for control and the warping shape for display until the position of the eye stops outside the eye box EB for control. For example, in the flowchart of FIG. 6, the process does not proceed to Step S30 and succeeding processing unless it is determined that the position of the eye has stopped at Step S20. Due to this, frequent update of the warping shape is suppressed. Additionally, in a case in which the position of the eye comes out of the eye box EB for control and immediately returns to the inside of the eye box EB for control, the eye box EB for control and the warping shape are not updated. Accordingly, hunting of control is suppressed.

The reference data TB according to the present embodiment includes the reference points Pi located along the vehicle width direction Y with respect to the same position in the vehicle upper and lower direction Z. Thus, in a case in which the position of the eye of the driver 200 moves in the vehicle width direction Y, an appropriate warping shape corresponding to the position of the eye is generated.

The controller 5 according to the present embodiment selects the reference points Pi surrounding the representative point PC of the eye box EB for control, and generates the warping shape for display by linear interpolation from a plurality of the warping shapes corresponding to the selected reference points Pi. For example, in the example described above with reference to FIG. 10, the warping shape WP20 for display is generated from the pieces of warping data WP1, WP2, WP4, and WP5. By such a generation method, an optimum warping shape corresponding to the position of the eye can be generated.

In a case of rotating the motor 7 at the time of updating the eye box EB for control, the controller 5 according to the present embodiment gradually changes the warping shape for display in accordance with rotation of the motor 7. Accordingly, transition of the warping shape with little sense of incongruity can be achieved.

Disposition of the reference points Pi is not limited to the disposition illustrated in FIG. 2. For example, four or more reference points Pi may be disposed along the vehicle upper and lower direction Z with respect to the same position in the vehicle width direction Y. For example, four or more reference points Pi may be disposed along the vehicle width direction Y with respect to the same position in the vehicle upper and lower direction z.

The shape of the eye box EB for control may be a square or a rectangle. The eye box EB for control may be a rectangle having the length in the vehicle width direction Y longer than the length in the vehicle upper and lower direction Z. In this case, sensitivity to movement of the position of the eye along the vehicle width direction Y is lowered. The length in the vehicle width direction Y of the eye box EB for control may be determined to allow movement of the position of the eye caused by action of the driver 200 who checks a meter or a mirror. The shape of the eye box EB for control may be a shape different from the rectangle.

The controller 5 may determine whether to update the eye box EB for control based on a sight line direction of the driver 200. For example, in a case in which a line of sight of the driver 200 is not directed to the virtual image Vi, the eye box EB for control is not necessarily updated. The controller 5 may determine whether the line of sight of the driver 200 is directed to the virtual image Vi in a case in which the position of the eye has stopped. In this case, in the flowchart of FIG. 6, it is determined whether the line of sight of the driver 200 is directed to the virtual image Vi when affirmative determination is made at Step S20. As a result of the determination, the process proceeds to Step S30 if affirmative determination is made such that the line of sight is directed to the virtual image Vi, and the process proceeds to Step S10 if negative determination is made.

Through such processing, unnecessary update of the warping shape can be suppressed. For example, when the driver 200 operates an appliance of the vehicle 100, the position of the eye may be deviated from the eye box EB for control when the driver 200 turns his/her eyes upon the appliance. In this case, the controller 5 can delay the determination of update until the driver 200 faces the virtual image Vi. The controller 5 determines whether the position of the eye is deviated from the eye box EB for control at the time when the driver 200 turns his/her eyes upon the virtual image Vi. If the position of the eye of the driver 200 is returned to a position before the operation after the operation of the appliance is ended, the eye box EB for control and the warping shape are not updated.

The display device 3 is not limited to the liquid crystal display device. The display device 3 may be, for example, a device that scans a transmissive screen with laser light and generates an image on the screen.

### First Modification of Embodiment

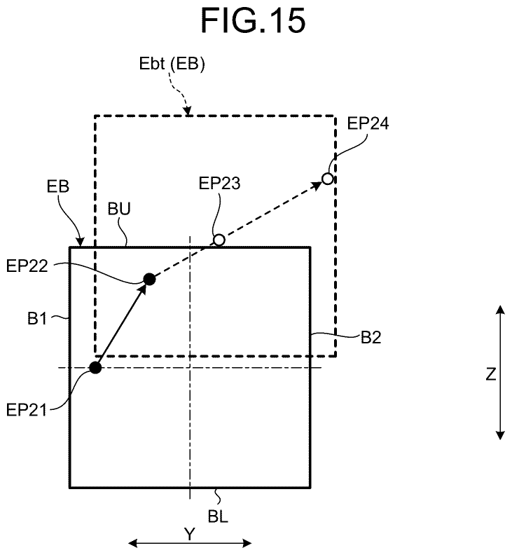

The following describes a first modification of the embodiment. FIG. 15 is a diagram for explaining update of the eye box for control according to the first modification of the embodiment. The controller 5 may update the eye box EB for control even if the position of the eye has not stopped in a case in which the position of the eye is deviated from the eye box EB for control. For example, as illustrated in FIG. 15, it is assumed that the position of the eye has moved from a point EP21 to a point EP22, and the position of the eye detected thereafter is a point EP23 outside the eye box EB for control. Even if the position of the eye does not stop at the point EP23, the controller 5 may update the eye box EB for control based on the point EP23. In this case, the controller 5 may cause a new eye box for control to be a temporary eye box EBt for control.

The controller 5 generates a new warping shape for the temporary eye box EBt for control, and gradually changes the warping shape. At this point, in a case in which the motor 7 is driven, the warping shape may be updated in a stepwise manner in accordance with driving of the motor 7.

It is assumed that the position of the eye stops at a point EP24 after the temporary eye box EBt for control is set. In this case, the controller 5 may update the eye box EB for control based on the point EP24. For example, the controller 5 may update the eye box EB for control regardless of whether the point EP24 is a point inside the temporary eye box EBt for control or a point outside thereof.

Alternatively, in a case in which the point EP24 is a point inside the temporary eye box EBt for control, the controller 5 does not necessarily update the eye box EB for control. For example, the controller 5 does not necessarily update the eye box EB for control in a case in which a distance from the point EP23 to the point EP24 is smaller than a lower limit value determined in advance.

### Second Modification of Embodiment

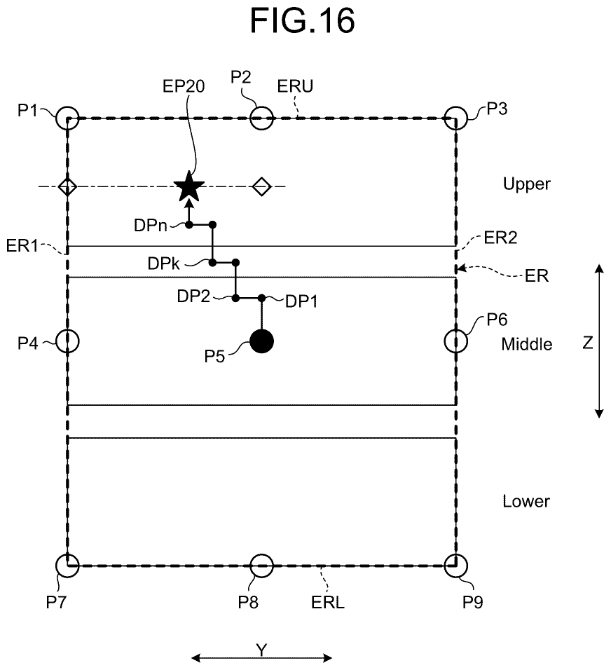

The following describes a second modification of the embodiment. FIG. 16 is a diagram illustrating intermediate points according to the second modification of the embodiment. Disposition of the intermediate points DPk is not necessarily linear disposition as illustrated in FIG. 14 in the embodiment described above. For example, as illustrated in FIG. 16, the intermediate points DPk may be disposed in a stepped form.

The pieces of content disclosed in the embodiment and modifications described above can be appropriately combined to be implemented.

A vehicle display device according to the present embodiment updates an eye box for control and a warping shape for display in a case in which a position of an eye of a driver is becomes a position outside the eye box for control. The vehicle display device according to the present embodiment exhibits an effect of being able to adjust the warping shape in accordance with the position of the eye while suppressing a sense of incongruity given to the driver.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A vehicle display device, comprising:
a display device configured to display an image;
a mirror configured to reflect display light of the image toward a reflective surface disposed in front of a driver;
a motor configured to change a projection position of the display light in a vehicle upper and lower direction by rotating the mirror;
a reference data defining a correspondence relation between a plurality of reference points and warping shapes, the reference points being located along the vehicle upper and lower direction and a vehicle width direction set for an eye range, the warping shapes corresponding to the respective reference points;
an acquisition unit configured to acquire a position of an eye of the driver; and
a controller configured to set an eye box for control, and generate a warping shape for display on the display device based on coordinates of a representative point of the eye box for control and the reference data, wherein
the controller updates the eye box for control and the warping shape for display in a case in which the position of the eye becomes a position outside the eye box for control, and
in a case in which a line of sight of the driver is not directed to a virtual image by the display light, the controller does not determine whether the position of the eye is outside position of the eye box for control.

2. The vehicle display device according to claim 1, wherein,
in a case in which the position of the eye comes out of the eye box for control, the controller does not start to update the eye box for control and the warping shape for display until the position of the eye stops outside the eye box for control.

3. The vehicle display device according to claim 1, wherein
the reference data includes the reference points located along the vehicle width direction with respect to the same position in the vehicle upper and lower direction.

4. The vehicle display device according to claim 1, wherein
the controller selects the reference points surrounding the representative point of the eye box for control, and generates the warping shape for display by linear interpolation from a plurality of warping shapes corresponding to the selected reference points.

5. The vehicle display device according to claim 1, wherein,
in a case of rotating the motor at the time of updating the eye box for control, the controller gradually changes the warping shape for display in accordance with rotation of the motor.

6. The vehicle display device according to claim 2, wherein,
in a case of rotating the motor at the time of updating the eye box for control, the controller gradually changes the warping shape for display in accordance with rotation of the motor.

7. The vehicle display device according to claim 3, wherein,
in a case of rotating the motor at the time of updating the eye box for control, the controller gradually changes the warping shape for display in accordance with rotation of the motor.

8. The vehicle display device according to claim 4, wherein,
in a case of rotating the motor at the time of updating the eye box for control, the controller gradually changes the warping shape for display in accordance with rotation of the motor.
